(19) United States
(12) Patent Application Publication
(10) Pub. No.: US 2025/0106696 A1
(43) Pub. Date: Mar. 27, 2025

(54) Methods And Apparatus For Enhancing Quality Of Service Based On Environmental Conservation In Mobile Communications

(71) Applicant: MediaTek Inc., Hsinchu City (TW)

(72) Inventors: Chien-Sheng Yang, Hsinchu City (TW); Chia-Lin Lai, Hsinchu City (TW); Yuan-Chieh Lin, Hsinchu City (TW); Yu-Hsin Lin, Hsinchu City (TW); I-Kang Fu, Hsinchu City (TW)

(21) Appl. No.: 18/792,262

(22) Filed: Aug. 1, 2024

Related U.S. Application Data
(60) Provisional application No. 63/584,213, filed on Sep. 21, 2023.
(60) Provisional application No. 63/584,215, filed on Sep. 21, 2023.

(51) Int. Cl. H04W 28/24; H04W 60/06; H04W 76/30

(52) U.S. Cl. CPC H04W 28/24; H04W 60/06; H04W 76/30

(57) ABSTRACT

Various solutions for enhancing quality of service (QoS) based on environmental conservation in mobile communications are described. An apparatus may determine whether an eco-friendly condition associated with a data session is met. Also, the apparatus may determine to modify a QoS associated with the data session in an event that the eco-friendly condition associated with the data session is met.

### CROSS REFERENCE TO RELATED PATENT APPLICATION(S)

The present disclosure is part of a non-provisional application claiming the priority benefit of U.S. Patent Application No. 63/584,213, filed 21 Sep. 2023, and U.S. Patent Application No. 63/584,215, filed 21 Sep. 2023. The contents of aforementioned applications are herein incorporated by reference in their entirety.

### TECHNICAL FIELD

The present disclosure is generally related to mobile communications and, more particularly, to enhancing quality of service (QoS) based on environmental conservation in mobile communications.

### BACKGROUND

Unless otherwise indicated herein, approaches described in this section are not prior art to the claims listed below and are not admitted as prior art by inclusion in this section.

It is observed that the Information/Communications Technology (ICT) industry is one of the biggest consumers of electricity. The ICT industry's estimated consumption of worldwide electricity stands at 2-3% today, and it is predicted to increase to around 8-21% by the year of 2030. Hence, it is important for the technology industry to consider not only how to reduce its electricity consumption, but also the transition to cleaner sources of energy. In addition, it is also important to derive the carbon-intensity of energy consumption, in order to determine the carbon footprint of network elements (e.g., hardware and/or software) when they are put into service. Electricity may be generated from various energy sources (e.g., gas, coal, nuclear, wind, and solar energy, etc.). with different levels of carbon emissions. In particular, due to the highly variable and unpredictable nature of renewable energy sources (e.g., wind and solar energy), carbon intensity (i.e., average carbon emissions per unit of energy consumption) of electricity grid varies considerably by time and location.

However, the current network frameworks do not introduce any appropriate solution to achieve eco-friendly requirements during communications between network entities. Therefore, there is a need to provide proper schemes to address this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods and/or apparatus pertaining to enhancing quality of service (QoS) based on environmental conservation in mobile communications. It is believed that the above-described issue would be avoided or otherwise alleviated by implementing one or more of the proposed schemes described herein.

In one aspect, a method may involve an apparatus determining whether an eco-friendly condition associated with a data session is met. The method may further involve the apparatus determining to modify a QoS associated with the data session in an event that the eco-friendly condition associated with the data session is met.

In one aspect, an apparatus may comprise a transceiver which, during operation, wirelessly communicates with a wireless network. The apparatus may also comprise a processor communicatively coupled to the transceiver. The processor, during operation, may perform operations comprising determining whether an eco-friendly condition associated with a data session is met. The processor may also perform operations comprising determining to modify a QoS associated with the data session in an event that the eco-friendly condition associated with the data session is met.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4A is a diagram depicting an example scenario under schemes in accordance with implementations of the present disclosure.

FIG. 4B is a diagram depicting an example scenario under schemes in accordance with implementations of the present disclosure.

FIG. 5 is a diagram depicting an example scenario under schemes in accordance with implementations of the present disclosure.

FIG. 6 is a block diagram of an example communication system in accordance with an implementation of the present disclosure.

FIG. 7 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to enhancing quality of service (QoS) based on environmental conservation in mobile communications. According to the present disclosure, a number of possible solutions may be implemented separately or jointly. That is, although these possible solutions may be described below separately, two or more of these possible solutions may be implemented in one combination or another.

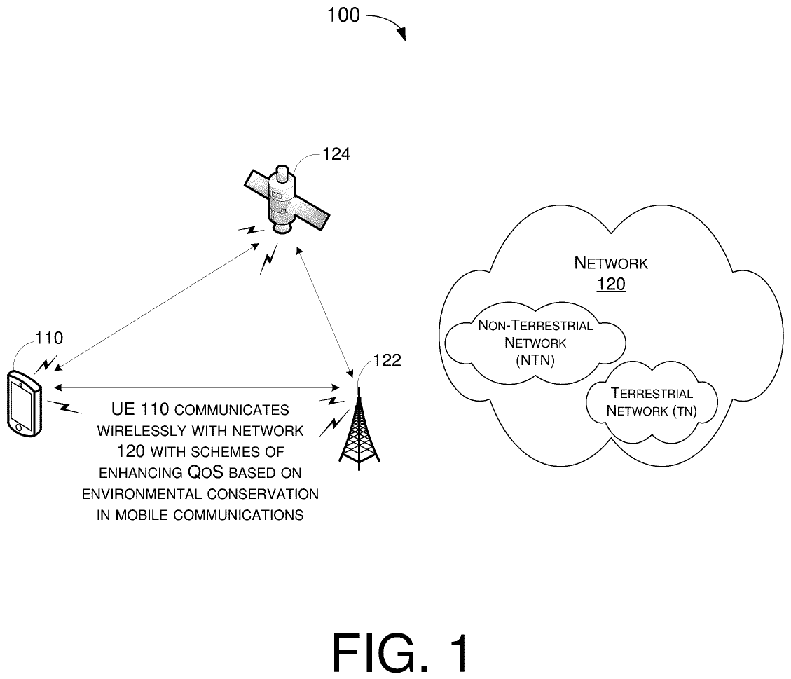

FIG. 1 illustrates an example scenario 100 of a communication environment in which various solutions and schemes in accordance with the present disclosure may be implemented. Scenario 100 involves a UE 110 in wireless communication with a network 120 (e.g., a wireless network including a non-terrestrial network (NTN) and a TN) via at least a terrestrial network node 122 (e.g., a base station (BS) such as an evolved Node-B (eNB), a Next Generation Node-B (gNB), or a transmission/reception point (TRP), or a (wireless-fidelity) access point (AP)) and/or at least a non-terrestrial network node 124 (e.g., a satellite). For example, the terrestrial network node 122 may form a TN serving cell for wireless communication with the UE 110, or the terrestrial network node 122 and/or the non-terrestrial network node 124 may form an NTN serving cell for wireless communication with the UE 110. In some implementations, the network 120 may be a 4G/5G/B5G/6G network, and the UE 110 may be a smartphone, a tablet computer, a laptop computer or a notebook computer. Alternatively, the network 120 may be an IoT/NB-IoT/IIoT network, and the UE 110 may be an IoT device such as an NB-IoT UE or an enhanced machine-type communication (eMTC) UE (e.g., a bandwidth reduced low complexity (BL) UE or a coverage enhancement (CE) UE). In the network 120, each network component, such as a radio access network (RAN) component (e.g., a cell formed by the terrestrial network node 122 and/or the non-terrestrial network node 124), and a core network (CN) component (e.g., a network slice, or a data network (name), etc.), may has a different eco-rating score. For example, some network node may use more renewable/green energy sources and thus, have a higher eco-rating score; or some network node may use more non-renewable/gray energy (e.g., on-grid power) sources and thus, have a lower eco-rating score. Additionally, the network 120 may include a core network with multiple network entities which may be implemented as software and/or hardware in one or more network nodes (e.g., computing devices/servers). For example, if the network 120 is a 5G system (5GS), the core network entities may include an access and mobility function (AMF), session management function (SMF), policy control function (PCF), unified data management (UDM), and network data analytics function (NWDAF), etc. If the network 120 is a 4G system (4GS), the core network entities may include mobility management entity (MME), serving gateway (S-GW), packet data network gateway (P-GW), and home subscriber server (HSS), etc. In such communication environment, the UE 110, the network 120, the terrestrial network node 122, and/or the non-terrestrial network node 124 may implement various schemes pertaining to enhancing QoS based on environmental conservation in mobile communications in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

Electricity/energy has a carbon intensity depending on where/when/how it is consumed and what sources it is generated from (e.g., solar power has lower carbon intensity, and fossil fuel has higher carbon intensity). In the real world, the availability of sustainable/renewable/green energy can vary significantly over time across different locations. An intensity may be referred to as a rate that has a numerator and a denominator. A rate may provide helpful information when considering how to design, develop, deploy, and operate green networks. For simplicity, in the present disclosure, the term “eco-rating” is used to accommodate both total amount and rate concepts regarding environmental impact. Specifically, eco-rating is a factor that is calculated taking environmental impact into account. For example, an eco-rating score may be the carbon intensity/efficiency/emission/footprint level (of energy/resource consumption) which may be further considered as a factor per service, per subscriber, per UE, per unit (e.g., byte) of data transmit/receive, or per network element (e.g., per BS, per CN element, or per application server, etc). Typically, a high eco-rating score means less environmental impact or greener (e.g., a better eco-rating, or a higher carbon efficiency rating) and higher sustainability (e.g., lower carbon intensity/efficiency/emission/footprint level (of energy/resource consumption)). A low eco-rating score means more environmental impact or less green (e.g., a worse eco-rating, or a lower carbon efficiency rating) and lower sustainability (e.g., higher carbon intensity/efficiency/emission/footprint level (of energy/resource consumption)).

It should be noted that other terms representing similar or the same green (i.e., eco-friendly) concept may be used as a substitute of the term “eco-rating” in the present disclosure. For example, energy efficiency may be used as a substitute of eco-rating, where high energy efficiency means less environmental impact (i.e., high eco-rating or greener), and low energy efficiency means more environmental impact (i.e., low eco-rating or less green). Energy consumption may also be used as a substitute of eco-rating, where low energy consumption means less environmental impact (i.e., high eco-rating or greener), and high energy consumption means more environmental impact (i.e., low eco-rating or less green). Green factor may also be used as a substitute of eco-rating, where high green factor means less environmental impact (i.e., high eco-rating or greener), and low green factor means more environmental impact (i.e., low eco-rating or less green). Carbon-intelligent or carbon-aware may be used to describe an approach that intends to achieve less environmental impact (i.e., high eco-rating or greener). Using more renewable/clean energy may also mean high eco-rating or greener.

In 4G/5G/B5G/6G network, QoS may be introduced as the measurement of the overall performance and effectiveness of a service offered by the network. QoS may encompass various aspects such as reliability, availability, latency, throughput, and error rate. In particular, QoS may ensure that different applications and users receive the required level of performance from the network, according to their specific needs and priorities. In telecommunications and networking, ensuring consistent and reliable service delivery may be essential. Furthermore, based on the properties of QoS, eco-friendly requirements may be achieved by controlling QoS in the network. For example, during a data session between network entities, if too much energy associated with the data session is consumed or too much carbon associated with the data session is emitted, the network may downgrade the QoS associated with the data session to reduce future energy consumption or carbon emissions, thus meeting eco-friendly requirements.

In some embodiments, at least one apparatus of the network entities (i.e., UE 110, the terrestrial network node 122, the non-terrestrial network node 124, the core network entities including AMF, SMF, PCF, UDM, NWDAF, MME, S-GW, P-GW, HSS, etc.) may determine whether an eco-friendly condition associated with a data session is met. If positive, the at least one apparatus may determine to modify a QoS associated with the data session. If negative, the at least one apparatus may determine to maintain the QoS associated with the data session. In some cases, the data session may be an established data session between the network entities.

In some implementations, parameter(s) associated with the eco-friendly condition may include an energy consumption quota, a carbon emission quota, a minimum requirement of renewable energy usage or a minimum requirement of eco-rating score.

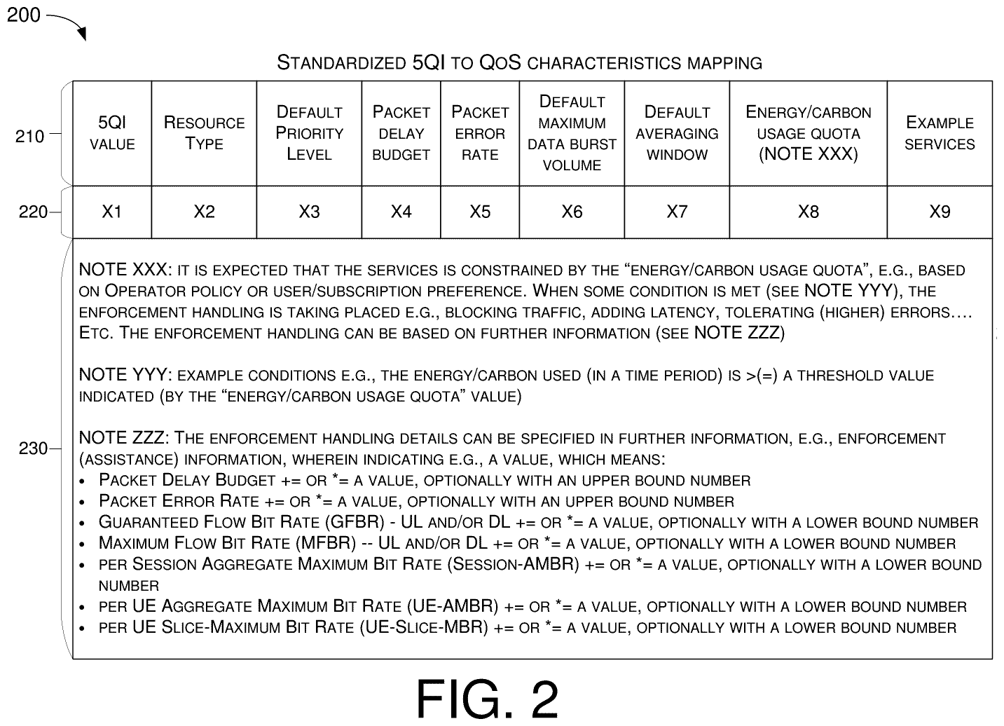

In some cases, the parameter(s) associated with the eco-friendly condition may be added into sections of 5G/6G QoS characteristics. For example, refer to FIG. 2 illustrating an example scenario 200 under schemes in accordance with implementations of the present disclosure, the parameter(s) associated with the eco-friendly condition is (are) added into a table of “Standardized 5G QoS Identifier (5QI) to QoS characteristics mapping.” In particular, for a specific QoS flow, section 210 indicates the related parameters and section 220 indicates the value X1 to X9 of the parameters. Regarding section 230 (starting at NOTE XXX) of detail related with parameter of energy/carbon usage quota, it is expected that the corresponding services are constrained by the “energy/carbon usage quota,” e.g., based on operator policy or user/subscription preference. When condition(s) is (are) met (refer to NOTE YYY), the enforcement handling is taking placed, e.g., blocking traffic, adding latency, tolerating (higher) error, etc. The enforcement handling is based on further information (refer to NOTE ZZZ). In NOTE YYY, the condition includes: the energy/carbon used (in a time period) is equal to or greater than a threshold value. In NOTE ZZZ, the enforcement handling details are specified in further information, e.g., enforcement (assistance) information, wherein indicating e.g., a value, which means:
(1) packet delay budget (PDB)+= or *=a value (i.e., a new value of PDB is a previous value of PDB plus or multiply the value), optionally with an upper bound number;
(2) packet error rate (PER)+= or *=a value (i.e., a new value of PER is a previous value of PER plus or multiply the value), optionally with an upper bound number;
(3) guaranteed flow bit rate (GFBR) UL and/or DL+= or *=a value (i.e., a new value of GFBR for DL/UL is a previous value of GFBR for DL/UL plus or multiply the value), optionally with a lower bound number;
(4) maximum flow bit rate (MFBR) UL and/or DL+= or *=a value (i.e., a new value of MFBR for DL/UL is a previous value of MFBR for DL/UL plus or multiply the value), optionally with a lower bound number;
(5) per session aggregate maximum bit rate (Session-AMBR)+= or *=a value (i.e., a new value of Session-AMBR is a previous value of Session-AMBR plus or multiply the value), optionally with a lower bound number;
(6) per UE aggregate maximum bit rate (UE-AMBR)+= or *=a value (i.e., a new value of UE-AMBR is a previous value of UE-AMBR plus or multiply the value), optionally with a lower bound number;
(7) per UE slice-maximum bit rate (UE-Slice-MBR)+= or *=a value (i.e., a new value of UE-Slice-MBR is a previous value of UE-Slice-MBR plus or multiply the value), optionally with a lower bound number.

For example, regarding a specific QoS flow, 5QI includes X1, Resource Type includes X2, Default Priority Level includes X3, packet delay budget includes X4, packet error rate includes X5, default maximum data burst volume includes X6, default averaging window includes X7, energy/carbon usage quota includes X8 and example services includes X9. In this example, energy/carbon usage quota indicates “positive” with an associated value ‘10,’ which means if energy/carbon used/emitted in a time period is equal to or greater than 10, some actions (enforcements) need to be performed. In this example, the actions include: (1) GFBR*=0.6, which means that the new GFBR is reduced 40%); and (2) notify charging function (e.g., to increase charging rate).

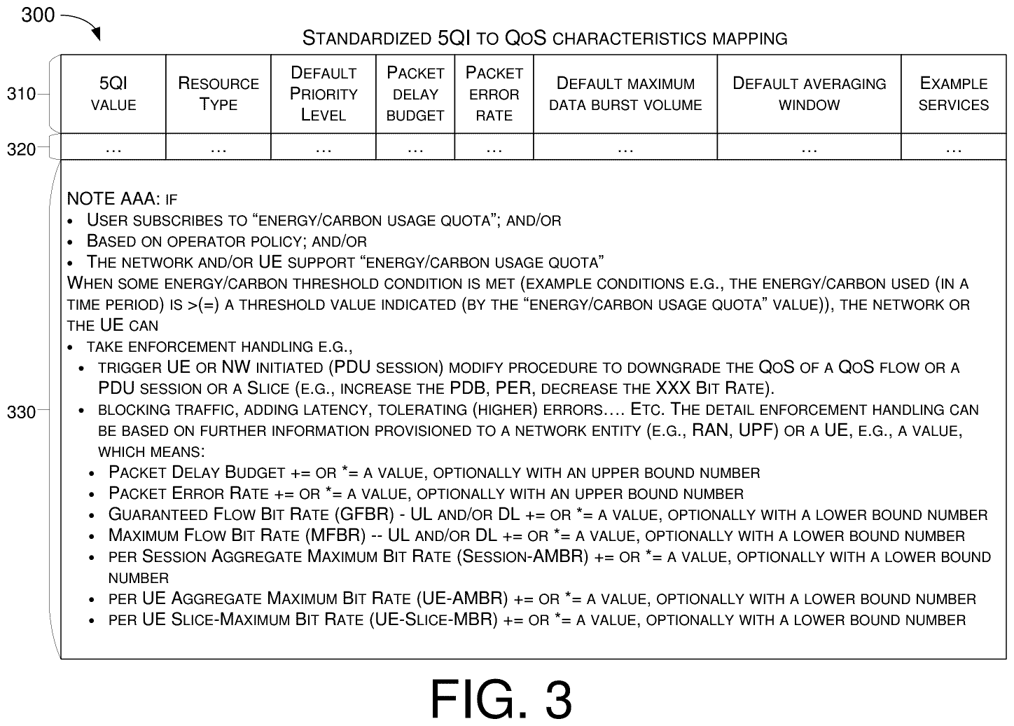

In some cases, the parameter(s) associated with the eco-friendly condition may be added into section of 5G/6G QoS characteristics. For example, refer to FIG. 3 illustrating an example scenario 300 under schemes in accordance with implementations of the present disclosure, the parameter(s) associated with the eco-friendly condition is (are) added into a table of “Standardized 5QI to QoS characteristics mapping.” In particular, for a specific QoS flow, section 310 indicates the related parameters and section 320 indicates the value Y1 to Y8 of the parameters. Regarding section 330 (starting at NOTE AAA) of detail related with the eco-friendly condition, under the scenarios that (a) user of UE subscribes to “energy/carbon usage quota”; and/or (b) operator policy allows; and/or (c) the network and/or UE support “energy/carbon usage quota”: when some energy/carbon condition(s) is (are) met (e.g., the energy/carbon used (in a time period) is equal to or greater than a threshold value), the network or the UE may take enforcement handling such as: (a) triggering UE or network to initiate session (e.g., packet data unit (PDU) session) modify procedure to downgrade the QoS of a QoS flow/a PDU session/a Slice (e.g., increase PDB, PER and/or decrease flow bit rate); and/or (b) blocking traffic, adding latency, tolerating (higher) error, etc. The detail of enforcement handling may be based on further information provisioned to a network entity (e.g., RAN, UPF, UE) as a value, which means:
(1) PDB+= or *=a value (i.e., a new value of PDB is a previous value of PDB plus or multiply the value), optionally with an upper bound number;
(2) PER+= or *=a value (i.e., a new value of PER is a previous value of PER plus or multiply the value), optionally with an upper bound number;
(3) GFBR UL and/or DL+= or *=a value (i.e., a new value of GFBR for DL/UL is a previous value of GFBR for DL/UL plus or multiply the value), optionally with a lower bound number;
(4) MFBR UL and/or DL+= or *=a value (i.e., a new value of MFBR for DL/UL is a previous value of MFBR for DL/UL plus or multiply the value), optionally with a lower bound number;
(5) per Session-AMBR+= or *=a value (i.e., a new value of Session-AMBR is a previous value of Session-AMBR plus or multiply the value), optionally with a lower bound number;
(6) per UE-AMBR+= or *=a value (i.e., a new value of UE-AMBR is a previous value of UE-AMBR plus or multiply the value), optionally with a lower bound number;
(7) per UE-Slice-MBR+= or *=a value (i.e., a new value of UE-Slice-MBR is a previous value of UE-Slice-MBR plus or multiply the value), optionally with a lower bound number.

For example, regarding a specific QoS flow, 5QI includes Y1, Resource Type includes Y2, Default Priority Level includes Y3, packet delay budget includes Y4, packet error rate includes Y5, default maximum data burst volume includes Y6, default averaging window includes Y7 and example services includes Y8. In this example, energy/carbon usage quota indicates “positive” with an associated value ‘10,’ which means if energy/carbon used/emitted in a time period is equal to or greater than 10, some actions (enforcements) need to be performed. In this example, the actions include: (1) GFBR*=0.6, which means that the new GFBR is reduced 40%); and (2) notify charging function (e.g., to increase charging rate).

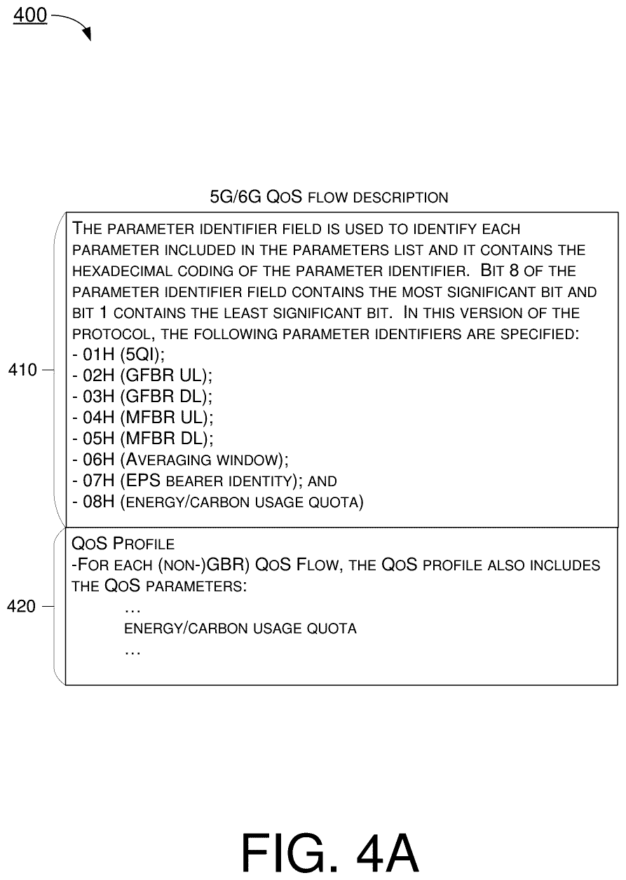

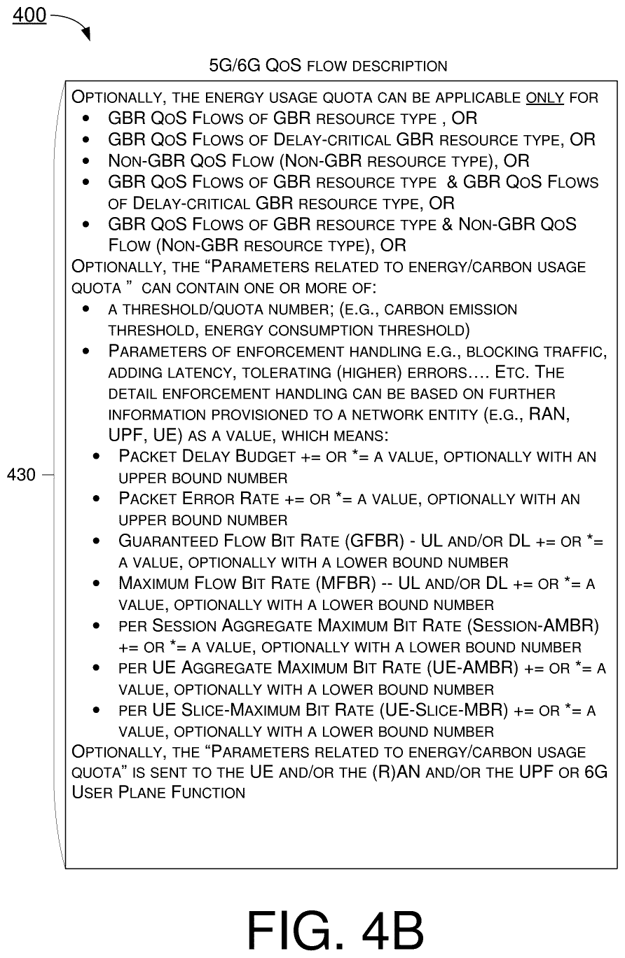

In some cases, the parameter(s) associated with the eco-friendly condition may be added into section of 5G/6G QoS flow descriptions. For example, refer to FIGS. 4A and 4B illustrating an example scenario 400 under schemes in accordance with implementations of the present disclosure, the parameter(s) associated with the eco-friendly condition is (are) added into section(s) of “5G/6G QoS flow descriptions.” In particular, parameter of the eco-friendly condition may be added into section 410 of “5G/6G QoS flow descriptions” or section 420 of “5G/6G QoS flow descriptions”, and the detail of the eco-friendly condition may be added in section 430 of “5G/6G QoS flow descriptions.” In section 410, the parameter of the eco-friendly condition may include “XXH energy/carbon usage quota.” In section 420, the parameter of the eco-friendly condition may include “energy/carbon usage quota.” In section 430, the detail the eco-friendly condition may include at least one of the following.

Optionally, the energy/carbon usage quota may be applicable only for
guaranteed bit rate (GBR) QoS flows of GBR resource type, or
GBR QoS flows of delay-critical GBR resource type, or
Non-GBR QoS flow (Non-GBR resource type), or
GBR QoS flows of GBR resource type and GBR QoS flows of delay-critical GBR resource type, or
GBR QoS flows of GBR resource type and Non-GBR QoS flow (Non-GBR resource type).

Optionally, the parameters related to energy/carbon usage quota may contain one or more of:
a threshold/quota number (e.g., carbon emission threshold, energy consumption threshold);
parameters of enforcement handling, e.g., blocking traffic, adding latency, tolerating (higher) errors, etc. The detail enforcement handling may be based on further information provisioned to a network entity (e.g., RAN, UPF, UE) as a value, which means:
(1) PDB+= or *=a value (i.e., a new value of PDB is a previous value of PDB plus or multiply the value), optionally with an upper bound number;
(2) PER+= or *=a value (i.e., a new value of PER is a previous value of PER plus or multiply the value), optionally with an upper bound number;
(3) GFBR UL and/or DL+= or *=a value (i.e., a new value of GFBR for DL/UL is a previous value of GFBR for DL/UL plus or multiply the value), optionally with a lower bound number;
(4) MFBR UL and/or DL+= or *=a value (i.e., a new value of MFBR for DL/UL is a previous value of MFBR for DL/UL plus or multiply the value), optionally with a lower bound number;
(5) per Session-AMBR+= or *=a value (i.e., a new value of Session-AMBR is a previous value of Session-AMBR plus or multiply the value), optionally with a lower bound number;
(6) per UE-AMBR+= or *=a value (i.e., a new value of UE-AMBR is a previous value of UE-AMBR plus or multiply the value), optionally with a lower bound number;
(7) per UE-Slice-MBR+= or *=a value (i.e., a new value of UE-Slice-MBR is a previous value of UE-Slice-MBR plus or multiply the value), optionally with a lower bound number.

Optionally, the parameters related to energy/carbon usage quota may be sent to UE and/or the RAN and/or 6G UPF.

In some implementations, the data session may include a PDU session. The step of determining whether the eco-friendly condition associated with the data session is met may include: (1) determining whether an energy consumption associated with the data session reaches a first threshold (e.g., the energy consumption quota); (2) determining whether a carbon emission associated with the data session reaches a second threshold (e.g., the carbon emission quota); (3) determining whether a renewable energy usage associated with the data session reaches a third threshold (e.g., the minimum requirement of renewable energy usage); or (4) determining whether an eco-rating score associated with the data session reaches a fourth threshold (e.g., the minimum requirement of eco-rating score).

For example, regarding the energy consumption, the at least one apparatus may determine whether the energy consumption is equal to or greater than the first threshold. If positive, it means that the energy associated with the PDU session may be consumed too much. Consequently, the at least one apparatus may downgrade the QoS associated with the PDU session to align with some eco-friendly requirements. It should be noted that the energy may include renewable energy produced from renewable sources and/or grey energy (i.e., grey electricity or traditional electricity) generated from conventional sources. The first threshold may be set as appropriate upper limit(s) for renewable energy and/or grey energy.

For example, regarding the carbon emission, the at least one apparatus may determine whether the carbon emission is equal to or greater than the second threshold. If positive, it means that the carbon associated with the PDU session may be emitted too much. Consequently, the at least one apparatus may downgrade the QoS associated with the PDU session to align with some eco-friendly requirements.

For example, regarding the renewable energy usage, the at least one apparatus may determine whether the renewable energy usage is less than or equal to the third threshold. If positive, it means that the usage of renewable energy associated with the PDU session may be not enough. Consequently, the at least one apparatus may downgrade the QoS associated with the PDU session to align with some eco-friendly requirements.

For example, regarding the eco-rating score, the at least one apparatus may determine whether the eco-rating score is less than or equal to the fourth threshold. If positive, it means that the eco-rating score associated with the PDU session may be too low, implying a higher consumption of non-renewable/grey energy. Consequently, the at least one apparatus may downgrade the QoS associated with the PDU session to align with some eco-friendly requirements.

In some implementations, the data session may include the PDU session, and the step of modifying the QoS associated with the data session in the event that the eco-friendly condition associated with the data session is met includes: (1) modifying the QoS of a QoS flow associated with the PDU session in the event that the eco-friendly condition associated with the PDU session is met; (2) modifying the QoS of the PDU session in the event that the eco-friendly condition associated with the PDU session is met; or (3) modifying the QoS of a slice associated with the PDU session in the event that the eco-friendly condition associated with the PDU session is met.

For example, regarding the QoS of the QoS flow, the at least one apparatus may modify at least one of a PER, a PDB and a flow bit rate in the event that the eco-friendly condition associated with the PDU session is met. More specifically, in the event that the eco-friendly condition associated with the PDU session is met, the at least one apparatus may: (1) increase at least one of the PER and the PDB of the QoS associated with the PDU session; and/or (2) decrease the flow bit rate of the QoS associated with the data session. In some cases, the increase of at least one of the PER and the PDB may have an upper limit, and the decrease of the flow bit rate may have a lower limit. The flow bit rate may include GFBR for DL/UL, MFBR for DL/UL, etc.

For example, regarding the QoS of the PDU session, the at least one apparatus may modify at least one of the PER, the PDB and the flow bit rate in the event that the eco-friendly condition associated with the PDU session is met. More specifically, in the event that the eco-friendly condition associated with the PDU session is met, the at least one apparatus may: (1) increase at least one of the PER and the PDB of the QoS associated with the PDU session; and/or (2) decrease the flow bit rate of the QoS associated with the data session. In some cases, the increase of at least one of the PER and the PDB may have an upper limit, and the decrease of the flow bit rate may have a lower limit. The flow bit rate may include per Session-AMBR for DL/UL, per UE-AMBR for DL/UL, etc.

For example, regarding the QoS of the slice, the at least one apparatus may modify at least one of the PER, the PDB and the flow bit rate in the event that the eco-friendly condition associated with the PDU session is met. More specifically, in the event that the eco-friendly condition associated with the PDU session is met, the at least one apparatus may: (1) increase at least one of the PER and the PDB of the QoS associated with the PDU session; and/or (2) decrease the flow bit rate of the QoS associated with the data session. In some cases, the increase of at least one of the PER and the PDB may have an upper limit, and the decrease of the flow bit rate may have a lower limit. The flow bit rate may include per UE-Slice-MBR for DL/UL, etc.

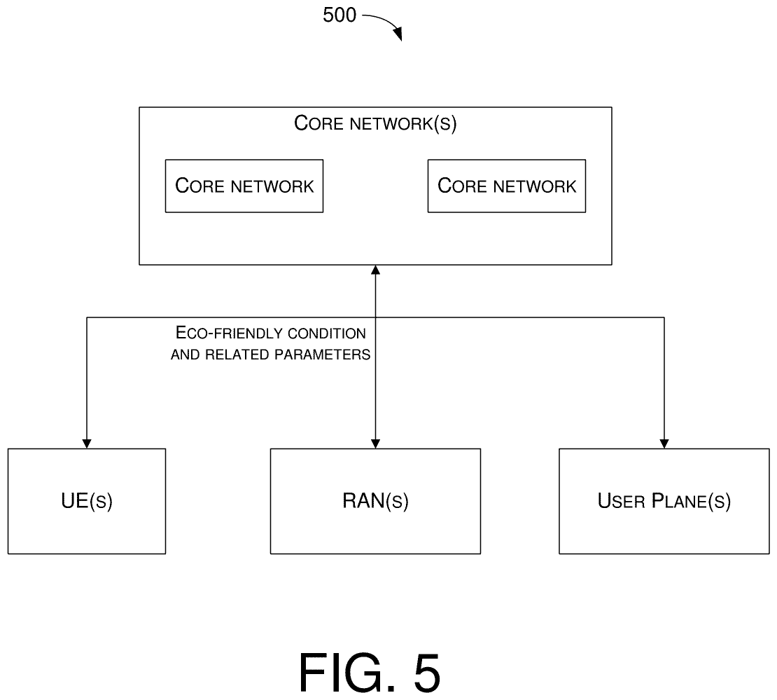

FIG. 5 illustrates an example scenario 500 of eco-friendly condition and related parameters transmission under schemes in accordance with implementations of the present disclosure. In some implementations, the at least one apparatus of the network entities may receive the eco-friendly condition from another network entity, e.g., a first core network.

In some cases, the first core network includes a core network function such as UDM, PCF, SMF, AMF, 6G-Core-NW-1, etc. The at least one apparatus of the network entities may include a second core network including a core network function such as user plane function (UPF), 6G-Core-NW-1, SMF, AMF, etc. After receiving the eco-friendly condition from the first core network, the second core network may then determine whether the eco-friendly condition associated with the data session is met.

In some cases, the first core network includes a core network function such as PCF, SMF, AMF, 6G-Core-NW-1, etc. The at least one apparatus of the network entities may include a RAN such as a 5G base station, a 6G base station, etc. After receiving the eco-friendly condition from the first core network, the RAN may then determine whether the eco-friendly condition associated with the data session is met.

In some cases, the first core network includes a core network control function such as AMF, SMF, etc. The at least one apparatus of the network entities may include a third core network including a core network user plane function such as UPF, a 5G base station, a 6G base station, etc. After receiving the eco-friendly condition from the first core network, the third core network may then determine whether the eco-friendly condition associated with the data session is met.

In some cases, the first core network includes a core network control function such as AMF, SMF, etc. The at least one apparatus of the network entities may include a UE. After receiving the eco-friendly condition from the first core network, the UE may then determine whether the eco-friendly condition associated with the data session is met.

In some implementations, a parameter of notification control may be used to indicate whether notifications of that the eco-friendly condition associated with the data session is met are requested from a RAN of the network entities or a core network UPF of the network entities when the eco-friendly condition associated with the data session is met for a QoS flow, a slice, a UE or one of the network entities. Accordingly, after determining that the eco-friendly condition associated with the data session is met, the at least one apparatus of the network entities may transmit an indication of whether the eco-friendly condition associated with the data session is met to the core network. In some cases, an SMF may enable notification control when the parameter of notification control is set in a policy or a subscription rule (e.g., policy and charging control (PCC) rule or unified data management (UMD) rule).

In some implementations, when the at least one apparatus of the network entities includes a RAN and the RAN determines that the eco-friendly condition associated with the data session is met, the RAN may: (1) reconfigure a radio resource control (RRC) connection; or (2) release the RRC connection.

In some implementations, when the at least one apparatus of the network entities includes a core network and the core network determines that the eco-friendly condition associated with the data session is met, the core network may: (1) release the data session or the QoS flow of the data session; (2) modify the data session or the QoS flow of the data session; or (3) deregister a UE of the network entities.

In some implementations, when the at least one apparatus of the network entities includes a UE and the UE determines that the eco-friendly condition associated with the data session is met, the UE may: (1) release the data session or the QoS flow of the data session; (2) modify the data session or the QoS flow of the data session; or (3) deregister from the network entities.

In some implementations, after the at least one apparatus of the network entities determines that the eco-friendly condition associated with the data session is met, the at least one apparatus of the network entities may transmit an indication to a UE of the network entities. The indication may indicate the UE of that the eco-friendly condition associated with the data session is met, thus a user of the UE may determine how to respond the indication. For example, when the core network of the network entities determines that the energy consumption associated with the data session is greater than a threshold, the core network may transmit a short message service (SMS) message or an over-the-top (OTT) message to the UE to inform the user of the UE that the energy consumption quota ran out. The user of the UE may then decide to buy more energy consumption quota or accept a downgrade of the QoS associated with the data session (e.g., network throttling).

### Illustrative Implementations

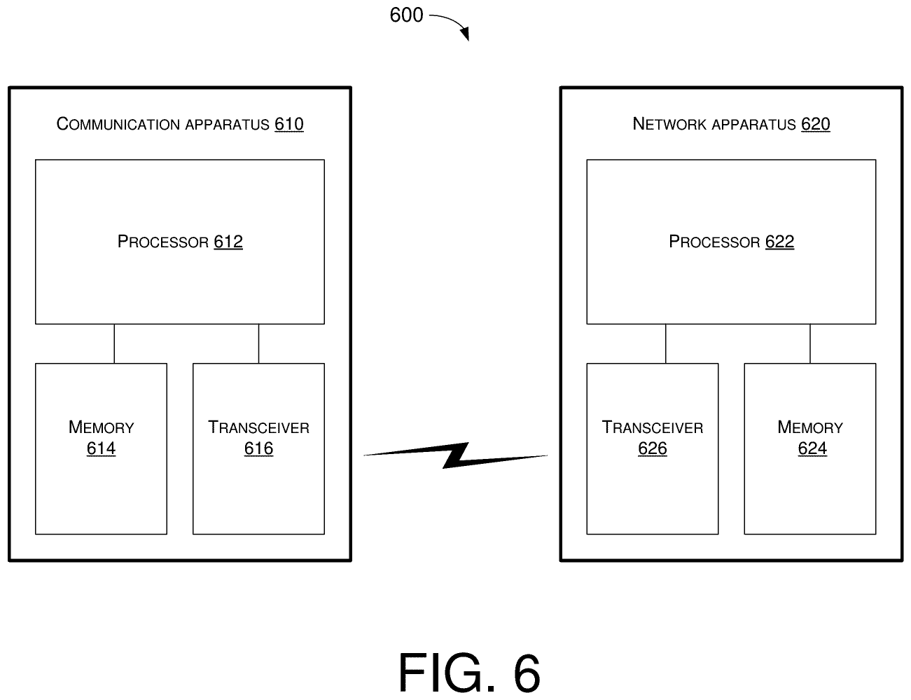

FIG. 6 illustrates an example communication system 600 having an example communication apparatus 610 and an example network apparatus 620 in accordance with an implementation of the present disclosure. Each of communication apparatus 610 and network apparatus 620 may perform various functions to implement schemes, techniques, processes and methods described herein pertaining to enhancing QoS based on environmental conservation in mobile communications, including scenarios/schemes described above as well as process 700 described below.

Communication apparatus 610 may be a part of an electronic apparatus, which may be a UE such as a portable or mobile apparatus, a wearable apparatus, a wireless communication apparatus or a computing apparatus. For instance, communication apparatus 610 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 610 may also be a part of a machine type apparatus, which may be an IoT, NB-IoT, eMTC, IIoT UE such as an immobile or a stationary apparatus, a home apparatus, a roadside unit (RSU), a wire communication apparatus or a computing apparatus. For instance, communication apparatus 610 may be implemented in a smart thermostat, a smart fridge, a smart door lock, a wireless speaker or a home control center. Alternatively, communication apparatus 610 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 610 may include at least some of those components shown in FIG. 6 such as a processor 612, for example. Communication apparatus 610 may further include one or more other components not pertinent to the proposed schemes of the present disclosure (e.g., internal power supply, display device and/or user interface device), and, thus, such component(s) of communication apparatus 610 are neither shown in FIG. 6 nor described below in the interest of simplicity and brevity.

Network apparatus 620 may be a part of an electronic apparatus, which may be a network node such as a core network, a satellite, a BS, a small cell, a router or a gateway of an IoT network. For instance, network apparatus 620 may be implemented in a core network, a satellite or an eNB/gNB/TRP in a 4G/5G/B5G/6G, NR, IoT, NB-IoT or IIoT network. Alternatively, network apparatus 620 may be implemented in the form of one or more IC chips such as, for example and without limitation, one or more single-core processors, one or more multi-core processors, or one or more RISC or CISC processors. Network apparatus 620 may include at least some of those components shown in FIG. 6 such as a processor 622, for example. Network apparatus 620 may further include one or more other components not pertinent to the proposed scheme of the present disclosure (e.g., internal power supply, display device and/or user interface device), and, thus, such component(s) of network apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks, including enhancing quality of service (QoS) based on environmental conservation in mobile communications, in a device (e.g., as represented by communication apparatus 610) and/or a network node (e.g., as represented by network apparatus 620) in accordance with various implementations of the present disclosure.

In some implementations, communication apparatus 610 may also include a transceiver 616 coupled to processor 612 and capable of wirelessly transmitting and receiving data. In some implementations, transceiver 616 may be capable of wirelessly communicating with different types of UEs and/or wireless networks of different radio access technologies (RATs). In some implementations, transceiver 616 may be equipped with a plurality of antenna ports (not shown) such as, for example, four antenna ports. That is, transceiver 616 may be equipped with multiple transmit antennas and multiple receive antennas for multiple-input multiple-output (MIMO) wireless communications. In some implementations, network apparatus 620 may also include a transceiver 626 coupled to processor 622. Transceiver 626 may include a transceiver capable of wirelessly transmitting and receiving data. In some implementations, transceiver 626 may be capable of wirelessly communicating with different types of UEs of different RATs. In some implementations, transceiver 626 may be equipped with a plurality of antenna ports (not shown) such as, for example, four antenna ports. That is, transceiver 626 may be equipped with multiple transmit antennas and multiple receive antennas for MIMO wireless communications.

In some implementations, communication apparatus 610 may further include a memory 614 coupled to processor 612 and capable of being accessed by processor 612 and storing data therein. In some implementations, network apparatus 620 may further include a memory 624 coupled to processor 622 and capable of being accessed by processor 622 and storing data therein. Each of memory 614 and memory 624 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 614 and memory 624 may include a type of read-only memory (ROM) such as mask ROM, programmable ROM (PROM), erasable programmable ROM (EPROM) and/or electrically erasable programmable ROM (EEPROM). Alternatively, or additionally, each of memory 614 and memory 624 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 610 and network apparatus 620 may be a communication entity capable of communicating with each other using various proposed schemes in accordance with the present disclosure. For illustrative purposes and without limitation, a description of capabilities of communication apparatus 610, as a UE, and network apparatus 620, as a RAN/CN network node (e.g., satellite/BS, or AMF/UPF), is provided below with process 700.

### Illustrative Processes

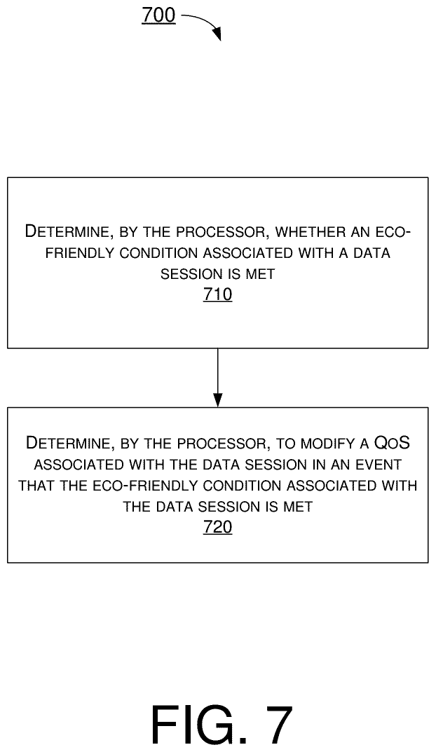

FIG. 7 illustrates an example process 700 under schemes in accordance with an implementation of the present disclosure. Process 700 may represent an aspect of implementing various proposed designs, concepts, schemes, systems and methods described above, whether partially or entirely, including those described above. More specifically, process 700 may represent an aspect of the proposed concepts and schemes pertaining to enhancing QoS based on environmental conservation in mobile communications. Process 700 may include one or more operations, actions, or functions as illustrated by one or more of blocks 710 and 720. Although illustrated as discrete blocks, various blocks of process 700 may be divided into additional blocks, combined into fewer blocks, or eliminated, depending on the desired implementation. Moreover, the blocks/sub-blocks of process 700 may be executed in the order shown in FIG. 7 or, alternatively in a different order. Furthermore, one or more of the blocks/sub-blocks of process 700 may be executed iteratively. Process 700 may be implemented by or in communication apparatus 610 and/or communication apparatus 620 as well as any variations thereof. Solely for illustrative purposes and without limiting the scope, process 700 is described below in the context of communication apparatus 610 as a UE and network apparatus 620 as a network node. Process 700 may begin at block 710.

At block 710, process 700 may involve processor 612/622 of communication apparatus 610/network apparatus 620 determining whether an eco-friendly condition associated with a data session is met. The data session may be an established data session. Process 700 may proceed from block 710 to block 720.

At block 720, process 700 may involve processor 612/622 determining to modify a QoS associated with the data session in an event that the eco-friendly condition associated with the data session is met.

In some implementations, the step of determining whether the eco-friendly condition associated with the data session is met may include: (1) determining whether an energy consumption associated with the data session reaches a first threshold; (2) determining whether a carbon emission associated with the data session reaches a second threshold; (3) determining whether a renewable energy usage associated with the data session reaches a third threshold; or (4) determining whether an eco-rating score associated with the data session reaches a fourth threshold.

In some implementations, the eco-rating score may indicate one of the following: an energy efficiency level, an energy consumption level, a carbon intensity, carbon efficiency, carbon emission, or carbon footprint level, and a renewable or clean energy level.

In some implementations, the data session includes a PDU session, and the step of determining to modify the QoS associated with the data session in the event that the eco-friendly condition associated with the data session is met may include: (1) determining to modify the QoS of a QoS flow associated with the PDU session in the event that the eco-friendly condition associated with the PDU session is met; (2) determining to modify the QoS of the PDU session in the event that the eco-friendly condition associated with the PDU session is met; or (3) determining to modify the QoS of a slice associated with the PDU session in the event that the eco-friendly condition associated with the PDU session is met.

In some implementations, the data session includes a PDU session, and the step of determining to modify the QoS associated with the data session in the event that the eco-friendly condition associated with the data session is met may include: determining, by the processor, to modify at least one of a PER, a PDB and a flow bit rate of the QoS associated with the PDU session in the event that the eco-friendly condition associated with the PDU session is met.

In some implementations, the step of determining to modify at least one of the PER, the PDB and the flow bit rate of the QoS associated with the PDU session in the event that the eco-friendly condition associated with the PDU session is met may include at least one step of: (1) determining to increase at least one of the PER and the PDB of the QoS associated with the PDU session in the event that the eco-friendly condition associated with the PDU session is met; and (2) determining to decrease the flow bit rate of the QoS associated with the PDU session in the event that the eco-friendly condition associated with the PDU session is met.

In some implementations, process 700 may further involve processor 612/622 of communication apparatus 610/network apparatus 620 receiving the eco-friendly condition from a network entity.

In some implementations, process 700 may further involve processor 612/622 of communication apparatus 610/network apparatus 620 transmitting an indication of whether the eco-friendly condition associated with the data session is met.

In some implementations, network apparatus 620 may include a RAN and process 700 may further involve processor 622 of network apparatus 620 reconfiguring an RRC connection in the event that the eco-friendly condition associated with the data session is met; or releasing the RRC connection in the event that the eco-friendly condition associated with the data session is met.

In some implementations, network apparatus 620 may include a core network and process 700 may further involve processor 622 of network apparatus 620 releasing the data session or a QoS flow of the data session in the event that the eco-friendly condition associated with the data session is met, determining to modify the data session or the QoS flow of the data session in the event that the eco-friendly condition associated with the data session is met, or deregistering a UE of the network entities in the event that the eco-friendly condition associated with the data session is met.

In some implementations, communication apparatus 610 may includes a UE and process 700 may further involve processor 612 of communication apparatus 610 releasing the data session or a QoS flow of the data session in the event that the eco-friendly condition associated with the data session is met, determining to modify the data session or the QoS flow of the data session in the event that the eco-friendly condition associated with the data session is met, or deregistering from the network entities in the event that the eco-friendly condition associated with the data session is met.

In some implementations, process 700 may further involve processor 622 of network apparatus 620 transmitting an indication of whether the eco-friendly condition associated with the data session is met to a UE.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, whether an eco-friendly condition associated with a data session is met; and
determining, by the processor, to modify a quality of service (QoS) associated with the data session in an event that the eco-friendly condition associated with the data session is met.

2. The method of claim 1, wherein the step of determining whether the eco-friendly condition associated with the data session is met includes:
determining, by the processor, whether an energy consumption associated with the data session reaches a first threshold;
determining, by the processor, whether a carbon emission associated with the data session reaches a second threshold;
determining, by the processor, whether a renewable energy usage associated with the data session reaches a third threshold; or
determining, by the processor, whether an eco-rating score associated with the data session reaches a fourth threshold.

3. The method of claim 2, wherein the eco-rating score indicates at least one of:
an energy efficiency level;
an energy consumption level;
a carbon intensity, carbon efficiency, carbon emission, or carbon footprint level; and
a renewable or clean energy level.

4. The method of claim 1, wherein the data session includes a packet data unit (PDU) session, and the step of determining to modify the QoS associated with the data session in the event that the eco-friendly condition associated with the data session is met includes:
determining, by the processor, to modify the QoS of a QoS flow associated with the PDU session in the event that the eco-friendly condition associated with the PDU session is met;
determining, by the processor, to modify the QoS of the PDU session in the event that the eco-friendly condition associated with the PDU session is met; or
determining, by the processor, to modify the QoS of a slice associated with the PDU session in the event that the eco-friendly condition associated with the PDU session is met.

5. The method of claim 1, wherein the data session includes a packet data unit (PDU) session, and the step of determining to modify the QoS associated with the data session in the event that the eco-friendly condition associated with the data session is met includes:
determining, by the processor, to modify at least one of a packet error rate (PER), a packet delay budget (PDB) and a flow bit rate of the QoS associated with the PDU session in the event that the eco-friendly condition associated with the PDU session is met.

6. The method of claim 5, wherein the step of determining to modify at least one of the PER, the PDB and the flow bit rate of the QoS associated with the PDU session in the event that the eco-friendly condition associated with the PDU session is met includes at least one step of:
determining, by the processor, to increase at least one of the PER and the PDB of the QoS associated with the PDU session in the event that the eco-friendly condition associated with the PDU session is met; and
determining, by the processor, to decrease the flow bit rate of the QoS associated with the PDU session in the event that the eco-friendly condition associated with the PDU session is met.

7. The method of claim 1, further comprising:
receiving, by the processor, the eco-friendly condition from a network entity.

8. The method of claim 1, further comprising:
transmitting, by the processor, an indication of whether the eco-friendly condition associated with the data session is met.

9. The method of claim 1, wherein the apparatus includes a radio access network (RAN), and the method further comprises:
reconfiguring, by the processor, a radio resource control (RRC) connection in the event that the eco-friendly condition associated with the data session is met; or
releasing, by the processor, the RRC connection in the event that the eco-friendly condition associated with the data session is met.

10. The method of claim 1, wherein the apparatus includes a core network, and the method further comprises:
releasing, by the processor, the data session or a QoS flow of the data session in the event that the eco-friendly condition associated with the data session is met;
determining, by the processor, to modify the data session or the QoS flow of the data session in the event that the eco-friendly condition associated with the data session is met; or
deregistering, by the processor, a user equipment (UE) in the event that the eco-friendly condition associated with the data session is met.

11. The method of claim 1, wherein the apparatus includes a user equipment (UE), and the method further comprises:
releasing, by the processor, the data session or a QoS flow of the data session in the event that the eco-friendly condition associated with the data session is met;
determining, by the processor, to modify the data session or the QoS flow of the data session in the event that the eco-friendly condition associated with the data session is met; or
deregistering, by the processor, from a network entity in the event that the eco-friendly condition associated with the data session is met.

12. The method of claim 1, further comprising:
transmitting, by the processor, an indication of whether the eco-friendly condition associated with the data session is met to a user equipment (UE).

13. An apparatus, comprising:
a transceiver which, during operation, communicates with a wireless network; and
a processor communicatively coupled to the transceiver such that, during operation, the processor performs operations comprising:
determining whether an eco-friendly condition associated with a data session is met; and
determining to modify a quality of service (QOS) associated with the data session in an event that the eco-friendly condition associated with the data session is met.

14. The apparatus of claim 13, wherein, during operation, the processor further performs operations comprising:
determining whether an energy consumption associated with the data session reaches a first threshold;
determining whether a carbon emission associated with the data session reaches a second threshold;
determining whether a renewable energy usage associated with the data session reaches a third threshold; or
determining whether an eco-rating score associated with the data session reaches a fourth threshold.

15. The apparatus of claim 13, wherein the data session includes a packet data unit (PDU) session, and, during operation, the processor further performs operations comprising:
determining to modify the QoS of a QoS flow associated with the PDU session in the event that the eco-friendly condition associated with the PDU session is met;
determining to modify the QoS of the PDU session in the event that the eco-friendly condition associated with the PDU session is met; or
determining to modify the QoS of a slice associated with the PDU session in the event that the eco-friendly condition associated with the PDU session is met.

16. The apparatus of claim 13, wherein the data session includes a packet data unit (PDU) session, and, during operation, the processor further performs operations comprising:
determining to modify at least one of a packet error rate (PER), a packet delay budget (PDB) and a flow bit rate of the QoS associated with the PDU session in the event that the eco-friendly condition associated with the PDU session is met.

17. The apparatus of claim 16, wherein, during operation, the processor further performs operations comprising at least one of:
determining to increase at least one of the PER and the PDB of the QoS associated with the PDU session in the event that the eco-friendly condition associated with the PDU session is met; and
determining to decrease the flow bit rate of the QoS associated with the PDU session in the event that the eco-friendly condition associated with the PDU session is met.

18. The apparatus of claim 13, wherein, during operation, the processor further performs operations comprising:
reconfiguring a radio resource control (RRC) connection in the event that the eco-friendly condition associated with the data session is met; or
releasing the RRC connection in the event that the eco-friendly condition associated with the data session is met.

19. The apparatus of claim 13, wherein, during operation, the processor further performs operations comprising:
releasing the data session or a QoS flow of the data session in the event that the eco-friendly condition associated with the data session is met;
determining to modify the data session or the QoS flow of the data session in the event that the eco-friendly condition associated with the data session is met; or
deregistering a user equipment (UE) in the event that the eco-friendly condition associated with the data session is met.

20. The apparatus of claim 13, wherein, during operation, the processor further performs operations comprising:
releasing the data session or a QoS flow of the data session in the event that the eco-friendly condition associated with the data session is met;
determining to modify the data session or the QoS flow of the data session in the event that the eco-friendly condition associated with the data session is met; or
deregistering from a network entity in the event that the eco-friendly condition associated with the data session is met.
